(19) United States
(12) Patent Application Publication
(10) Pub. No.: US 2024/0256721 A1
(43) Pub. Date: Aug. 1, 2024

(54) ENVIRONMENTAL MODELING FOR COMPUTER-AIDED DESIGN

(71) Applicant: INTERNATIONAL BUSINESS MACHINES CORPORATION, Armonk, NY (US)

(72) Inventors: Tyler HANSEN, TUCSON, AZ (US); James E. BROWN, Sugarhill, GA (US); Zachary A. Silverstein, Georgetown, TX (US); Logan Bailey, Atlanta, GA (US)

(21) Appl. No.: 18/162,235

(22) Filed: Jan. 31, 2023

(51) Int. Cl. G06F 30/12; B29C 64/393; B33Y 50/02; G06Q 30/04

(52) U.S. Cl. CPC G06F 30/12; B29C 64/393; B33Y 50/02; G06Q 30/04; G06F 2111/18; G06F 2113/10

(57) ABSTRACT

Described are techniques for infusing environmental data into a Computer-Aided Design (CAD) workspace. The techniques include replicating a physical area in a CAD workspace, where a static object of the physical area is replicated in the CAD workspace with a single set of coordinates, and where a dynamic object of the physical area is replicated in the CAD workspace with a range of coordinates representing movement. The techniques further include using the CAD workspace to enable relative sizing of a modeled object in the CAD workspace, where the relative sizing is relative to the single set of coordinates associated with the static object and the range of coordinates associated with the dynamic object.

### BACKGROUND

The present disclosure relates to Computer-Aided Design (CAD) modeling, and, more specifically, to replicating a physical environment in CAD systems.

CAD systems enable designers and engineers to create, modify, analyze, and/or optimize designs of physical products in a computer workspace. CAD systems can utilize vector-based graphics, raster graphics, or other graphic techniques to represent a physical product as a simulated three-dimensional (3D) object and/or as a two-dimensional (2D) technical drawing. Objects designed in CAD systems can subsequently be fabricated by, for example, additive manufacturing.

Additive manufacturing includes manufacturing techniques such as 3D printing. In 3D printing, material is deposited layer-by-layer to create a component. 3D printing can be useful in applications requiring unique, delicate, complex, and/or interior geometries that are more efficient to manufacture using 3D printing than other manufacturing techniques. Further, 3D printing can be useful in applications such as prototype manufacturing and/or custom manufacturing. For example, 3D printing can be used to fabricate components to fix, alter, and/or augment existing products.

However, CAD modeling for rapid prototyping can suffer from inefficiencies. For example, correctly dimensioning a customized model is time-consuming and error-prone. More specifically, dimensioning a customized model to fit into an existing system or environment can involve a user measuring other elements of the system or environment and approximating a dimension for the customized model based on the measurements of the other elements. This method can be time-consuming and error-prone if a user is unable to simulate the interaction of the customized model in the system or environment, thereby increasing the risk of unforeseen interferences.

### SUMMARY

Aspects of the present disclosure are directed toward a computer-implemented method including extracting, by augmented reality mapping techniques, contextual information from at least one image of a physical area including a static object and a dynamic object. The method further includes replicating the physical area in a Computer Aided Design (CAD) workspace using the contextual information, where the static object is associated with a single set of coordinates, and where the dynamic object is associate with a range of coordinates representing movement. The method further includes generating a print file for a modeled object created in the CAD workspace, where the print file includes computer-readable instructions for fabricating the modeled object by additive manufacturing.

Advantageously, the aforementioned method enables environmental data of a physical area to be infused into a CAD workspace. As a result, the aforementioned method enables efficient and accurate modeling of objects in the CAD workspace for future placement in the physical area.

In some additional embodiments, the aforementioned method further includes transmitting the print file to an additive manufacturing system, fabricating a printed object corresponding to the modeled object using the additive manufacturing system and the print file, generating orientation instructions for orienting the printed object in the physical area, and transmitting the orientation instructions to a user device.

Advantageously, these embodiments of the present disclosure enable a printed object to be placed in the physical area in a manner consistent with the placement of the modeled object in the replicated physical area of the CAD workspace.

Additional aspects of the present disclosure are directed toward a computer-implemented method including replicating a physical area in a Computer Aided Design (CAD) workspace, where a static object of the physical area is replicated in the CAD workspace with a single set of coordinates, and where a dynamic object of the physical area is replicated in the CAD workspace with a range of coordinates representing movement. The method further includes using the CAD workspace to enable relative sizing of a modeled object in the CAD workspace, where the relative sizing is relative to the single set of coordinates associated with the static object and the range of coordinates associated with the dynamic object.

Advantageously, the aforementioned method enables efficient and accurate modeling of objects in the CAD workspace by allowing relative sizing of the modeled object relative to objects in the replicated physical area.

Additional aspects of the present disclosure including the aforementioned method further include using the CAD workspace to enable relative positioning of the modeled object in the CAD workspace, where the relative positioning is relative to the single set of coordinates associated with the static object and the range of coordinates associated with the dynamic object.

Advantageously, using relative positioning for the modeled object can increase fit and function of the modeled object by limiting the instances of interference when a corresponding printed object is placed in a corresponding physical area.

Additional aspects of the present disclosure are directed toward a system including a Light Ranging And Detection (LIDAR) system configured to generate spatial data for a physical area. The system further includes a computer implementing CAD environmental modeling code configured to replicate the physical area in a CAD workspace using the spatial data and generate a print file corresponding to a modeled object created in the CAD workspace. The system further includes an additive manufacturing system configured to fabricate a printed object corresponding to the modeled object and based on the print file. The system further includes a user device configured to receive orientation instructions for placing the printed object in the physical area.

Advantageously, the aforementioned system improves efficient and accurate rapid prototyping by infusing environmental data of a physical area into a CAD workspace, modeling an object in the replicated physical area, and fabricating the modeled object using additive manufacturing.

Additional embodiments including the limitations of the aforementioned system further include that the user device is further configured to receive imaging instructions for adjusting the LIDAR system to generate additional spatial data for the physical area, and where replicating the physical area in the CAD workspace is further based on the additional spatial data.

Advantageously, the aforementioned embodiments improve the accuracy of the replicated physical area by providing instructions for obtaining additional spatial data, such as spatial data reflecting a range of movement of one or more items in the physical area.

Additional aspects of the present disclosure are directed to systems and computer program products configured to perform the methods described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example computational environment implementing CAD environmental modeling code, in accordance with some embodiments of the present disclosure.

FIG. 2 illustrates a flowchart of an example method for implementing the CAD environmental modeling code to enable replication of a physical area in a CAD workspace and usage of the CAD workspace, in accordance with some embodiments of the present disclosure.

FIG. 3 illustrates a flowchart of an example method for implementing the CAD environmental modeling code to enable relative sizing and/or relative positioning in a CAD workspace replicating a physical area, in accordance with some embodiments of the present disclosure.

FIG. 4 illustrates a flowchart of an example method for downloading, deploying, metering, and billing usage of CAD environmental modeling code, in accordance with some embodiments of the present disclosure.

FIG. 5 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward Computer-Aided Design (CAD) modeling, and, more specifically, to replicating a physical environment in CAD systems. While not limited to such applications, embodiments of the present disclosure may be better understood in light of the aforementioned context.

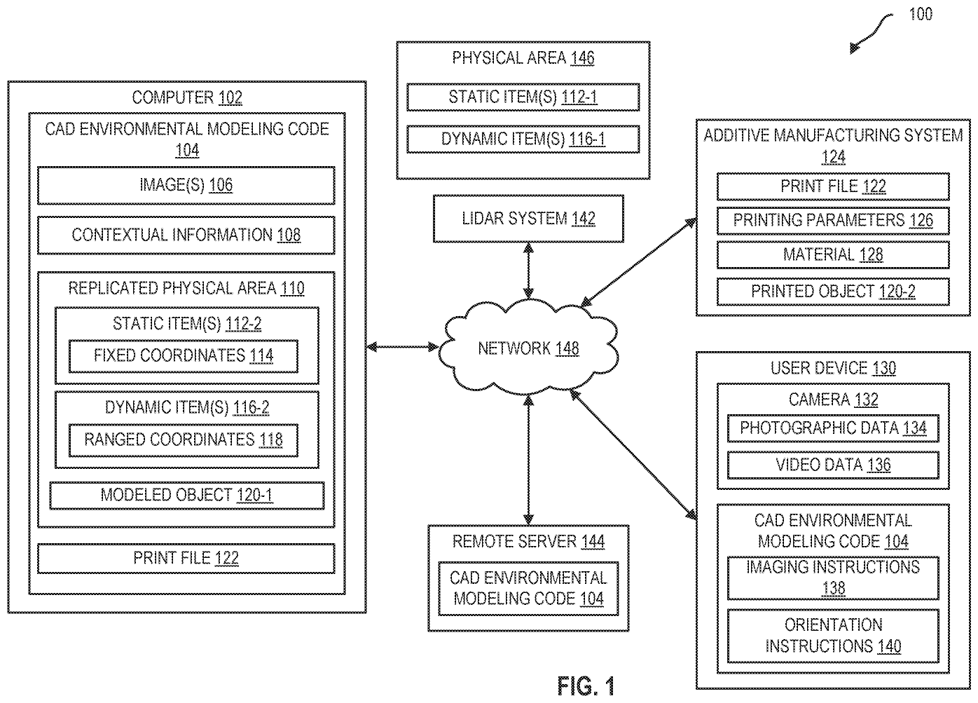

FIG. 1 illustrates a block diagram of an example computational environment 100 implementing CAD environmental modeling code 104, in accordance with some embodiments of the present disclosure. The example computational environment 100 includes a computer 102 communicatively coupled to an additive manufacturing system 124, user device 130, Light Detection And Ranging (LIDAR) system 142, and remote server 144 via a network 148. The computational environment 100 can be associated with a physical area 146, where data from the physical area 146 can be used by other elements of the computational environment 100.

The network 148 can be a local area network (LAN), a wide area network (WAN), an intranet, the Internet, or any other network 148 or group of networks 148 capable of continuously, semi-continuously, or intermittently connecting (directly or indirectly) the aforementioned components together.

Computer 102 can be any computational configuration of hardware and/or software capable of storing and/or implementing CAD environmental modeling code 104. In some embodiments, computer 102 can be any server, computer, desktop, laptop, tablet, mainframe, or other combination of computer hardware capable of executing software. In some embodiments, computer 102 can be a virtual machine (VM), container instance, or other virtualized combination of discrete physical hardware resources.

Remote server 144 can be any computational configuration of hardware and/or software as previously described with respect to computer 102. User device 130 can be any computational system including a user interface and capable of generating photographic data 134, video data 136, and/or other data related to the physical area 146. For example, user device 130 can be a smartphone, tablet, laptop, or other device.

LIDAR system 142 can be any system, now known or later developed, that utilizes lasers to detect ranges to physical objects and compiles those ranges to map an area. Although LIDAR is discussed herein, any system that utilizes acoustical, magnetic, infrared, ultraviolet, and/or electromagnetic techniques to perform mapping of an area can likewise be used, in accordance with various embodiments of the present disclosure.

Additive manufacturing system 124 can refer to any additive manufacturing system, now known or later developed. Additive manufacturing (also referred to as three-dimensional (3D) printing) involves receiving a CAD model, parsing the CAD model into numerous layers to generate a print file 122, and then printing each layer sequentially to physically manufacture a component based on the CAD model. The printing can function by any number of techniques and processes that are configured to fuse, join, or otherwise combine material. For example, 3D printing can be performed by fused-filament fabrication (FFF), vat photopolymerization, material jetting, binder jetting, powder bed fusion, material extrusion, directed energy deposition, sheet lamination, stereolithography (SLA), and/or other 3D printing techniques.

Referring back to computer 102, it can implement CAD environmental modeling code 104. In some embodiments, the CAD environmental modeling code 104 is downloaded to the computer 102 from the remote server 144. In other embodiments, the implementation of CAD environmental modeling code 104 is distributed between the computer 102, the remote server 144, the user device 130, and/or the additive manufacturing system 124. In such embodiments, the computer 102 can perform some features of the CAD environmental modeling code 104 and other elements of FIG. 1 can implement other features of the CAD environmental modeling code 104.

CAD environmental modeling code 104 can receive images 106 of the physical area 146. The images 106 can be generated from photographic data 134 from the camera 132 in the user device 130, video data 136 from camera 132 in the user device 130, and/or data generated by the LIDAR system 142. In some embodiments, CAD environmental modeling code 104 provides imaging instructions 138 to the user device 130 to direct the user to provide additional images 106. For example, the imaging instructions 138 can instruct a user to gather additional photographic data 134, video data 136, and/or data from LIDAR system 142 from a different vantage point or after manipulating the physical area 146 (e.g., by actuating movement patterns in the dynamic items 116-1, such as by opening a door).

The CAD environmental modeling code 104 can be configured to generate contextual information 108 from the images 106. Contextual information 108 can identify components of the physical area 146, such as static items 112-1 and dynamic items 116-1. Static items 112-1 can refer to stationary objects whereas dynamic items 116-1 can refer to objects configured to move. Such movement can comprise rotation, extension, retraction, articulation, translation, and/or other movements or combinations of movements. The movement can be enabled by connectors (e.g., hinges, rollers, pins, ball-in-socket connections) and/or ergonomic features (e.g., handles, knobs, buttons, etc.).

The CAD environmental modeling code 104 can be configured to generate replicated physical area 110 using the images 106 and/or the contextual information 108. The replicated physical area 110 can include representations of the static items 112-2 corresponding to the static items 112-1 in the physical area 146 and dynamic items 116-2 corresponding to the dynamic items 116-1 in the physical area 146. The static items 112-2 can be associated with fixed coordinates 114. In other words, static items 112-2 are stationary in the replicated physical area 110 (consistent with their stationary nature in the physical area 146). In contrast, the dynamic items 116-2 are associated with ranged coordinates 118. The ranged coordinates 118 include ranges of coordinates in a multidimensional space (e.g., Cartesian coordinates, Euclidean coordinates, spherical coordinates, cylindrical coordinates, polar coordinates, epipolar coordinates, etc.) and represent movement patterns associated with the dynamic items 116-1. For example, door can be a dynamic item 116-1 in the physical area 146. The door can be infused into the replicated physical area 110 as a dynamic item 116-2 and associated with ranged coordinates 118 enabling the door to move through the range of its motion in the replicated physical area 110 of the CAD workspace.

The generation of contextual information 108, static items 112-2, fixed coordinates 114, dynamic items 116-2, and/or ranged coordinates 118 can utilize computer vision, machine learning (ML), deep learning, and/or augmented reality (AR) technology. More specifically, image processing methods such as feature detection, corner detection, blob detection, edge detection, and thresholding can be used. Furthermore, data from the image processing methods can be converted to a virtual coordinate system using, for example, projective (e.g., epipolar) geometry, geometric algebra, rotation representation with exponential mapping, Kalman and/or particle filters, nonlinear optimization, and the like.

When ML is used, ML models can be generated from historical datasets of images, and the trained ML model can be configured to ingest images 106 and output contextual information 108, static items 112-2, fixed coordinates 114, dynamic items 116-2, and/or ranged coordinates 118. ML algorithms can include, but are not limited to, decision tree learning, association rule learning, artificial neural networks, deep learning, inductive logic programming, support vector machines, clustering, Bayesian networks, reinforcement learning, representation learning, similarity/metric training, sparse dictionary learning, genetic algorithms, rule-based learning, and/or other machine learning techniques.

For example, the ML algorithms can utilize one or more of the following example techniques: K-nearest neighbor (KNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other ML techniques.

Referring back to CAD environmental modeling code 104, it can be configured to enable a user operating the computer 102 to generate modeled object 120-1 in the replicated physical area 110 of the CAD workspace. Advantageously, generating the modeled object 120-1 in the replicated physical area 110 can enable a designer or engineer to more efficiently design for fit and function than modeling components in isolation. For example, in some embodiments, the modeled object 120-1 is dimensioned by relative sizing, where the relative sizing characterizes a dimension of the modeled object 120-1 based on the dimension of a static item 112-2 or dynamic item 116-2. As another example, in some embodiments, the modeled object 120-1 is dimensioned by relative positioning, where the relative positioning characterizes a position or dimension of the modeled object 120-1 based on a spacing between multiple static items 112-2 and/or dynamic items 116-2.

The CAD environmental modeling code 104 can further be configured to generate a print file 122 corresponding to the modeled object 120-1. The print file 122 can include, for example, a representation of a CAD model (e.g., modeled object 120-1) that is stored in, for example, a stereolithography (STL) file format. Print file 122 can include information related to dimensions, tolerances, features, materials, and the like. The print file 122 can isolate the modeled object 120-1 from the replicated physical area 110 and selectively generate printing parameters of the modeled object 120-1 as though it were modeled in isolation. The print file 122 can include computer-readable instructions for fabricating the modeled object by additive manufacturing. In some embodiments, the print file 122 can be transmitted to the additive manufacturing system 124. For example, the print file 122 can be transmitted via the network 148. In other embodiments, the print file 122 can be loaded onto a portable storage device (e.g., a Universal Serial Bus (USB) drive) and transferred to the additive manufacturing system 124 using the portable storage device.

The additive manufacturing system 124 can receive the print file 122 and generate printing parameters 126 based on the print file 122, material 128, and/or other configurations related to the additive manufacturing system 124. The additive manufacturing system 124 can subsequently fabricate, using material 128, a printed object 120-2 corresponding to the modeled object 120-1.

The additive manufacturing system 124 can utilize the printing parameters 126 to successfully fabricate the printed object 120-2. For example, in FFF, printing parameters 126 can be related to nozzle feed rates, nozzle speeds, nozzle backpressure, nozzle temperature, nozzle dwell time, nozzle orifice geometry, nozzle path, etc. As another example, in SLA, printing parameters 126 can be related to light patterns, light intensities (or wavelengths), light pattern durations, gap-widths between a base plate and the light source, etc. Printing parameters 126 can further utilize material characteristics in generating any of the aforementioned parameters such as a material type, a material melting point, a material glass transition temperature, a rheological profile of the material (e.g., viscosity, viscosity as a function of shear rate, etc.), a material elasticity profile as a function of temperature, and the like. For example, a material melting point can be useful for defining nozzle temperature. As another example, a rheological profile of the material can be useful for defining nozzle feed rate, nozzle back pressure, and/or nozzle orifice size and/or geometry.

A variety of materials 128 can be used by the additive manufacturing system 124. These materials can include thermoplastics that are heated to a flowing point, deposited according to the layer-by-layer deposition protocol, and allowed to cool to solidify and bind with any adjacent material. In other embodiments, these materials can include thermosets that are initially liquid before undergoing an irreversible chemical reaction (e.g., cross-linking) when exposed to a catalyst (e.g., light, temperature, pressure, chemical, etc.). In some situations, multiple materials are used, or similar materials are used with different modifiers, reinforcements, and/or fillers for color, strength, magnetism, and/or other customized aesthetic or structural properties.

Some non-limiting examples of material 128 can include thermoplastics such as acrylonitrile butadiene styrene (ABS), thermoplastic elastomers (TPEs), thermoplastic urethanes (TPUs), poly-lactic acid (PLA), polystyrene (PS), high-impact polystyrene (HIPS), polyethylene (PE), polyethylene terephthalate (PET), polyethylene terephthalate glycol-modified (PETG), polypropylene (PP), nylon, acrylonitrile styrene acrylate (ASA), polycarbonate (PC), polyvinyl alcohol (PVA), and others. Some non-limiting examples of material 128 can include thermosets such as polyesters, polyurethans, polyureas, vulcanized rubbers, phenol-formadehydes, epoxies, polyimides, cyanate esters, silicones, vinyl esters, and others. Although not explicitly shown, the material 128 can include any number of additives useful for improving processability, improving longevity, and/or improving mechanical, electrical, and/or temperature properties. For example, the material 128 can include plasticizers, nucleating agents, desiccants, impact modifiers, chain extenders, stabilizers, carboxyl scavengers, fillers (e.g., mineral, wood, metal, aramid, carbon, graphite, etc.), and the like. In some embodiments, material 128 can include reinforcement (e.g., short-fiber reinforcement, long-fiber reinforcement, continuous fiber reinforcement, etc.). Reinforcements can include, for example, carbon fiber, aramid fiber, and/or other types of natural or artificial fibers, now known or later developed.

The printed object 120-2 can be placed in the physical area 146. In some embodiments, CAD environmental modeling code 104 is configured to transmit orientation instructions 140 to the user device 130 to assist the user in properly positioning the printed object 120-2 in the physical area 146. The orientation instructions 140 can include, for example, a rendered image of the replicated physical area 110 including the modeled object 120-1 and, optionally, dimensions, arrows, text, and/or other indicators useful for properly placing the printed object 120-2 in the physical area 146 consistently with the positioning of the modeled object 120-1 in the replicated physical area 110. In some embodiments, a user can take an image of the printed object 120-2 placed in the physical area 146 using camera 132, provide the image to the CAD environmental modeling code 104, and the CAD environmental modeling code 104 can transmit updated orientation instructions 140 to the user device 130, where the updated orientation instructions 140 can describe and/or illustrate adjustments to the placement of the printed object 120-2 in the physical area 146 in order to be consistent with the placement of the modeled object 120-1 in the replicated physical area 110.

FIG. 1 is for illustrative purposes and should not be construed as limiting. More, fewer, and/or different components than the components illustrated in FIG. 1 can be present while remaining within the spirit and scope of the present disclosure. Further, illustrated components can be separated into multiple, discrete components, and/or multiple discrete components can be combined into a single component, while remaining within the spirit and scope of the present disclosure.

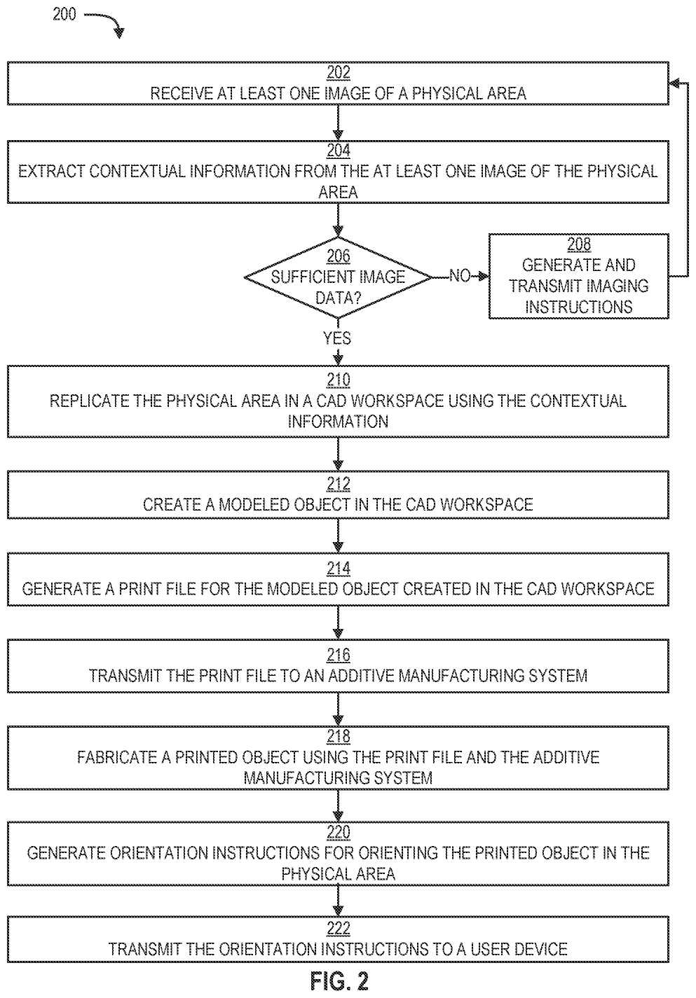

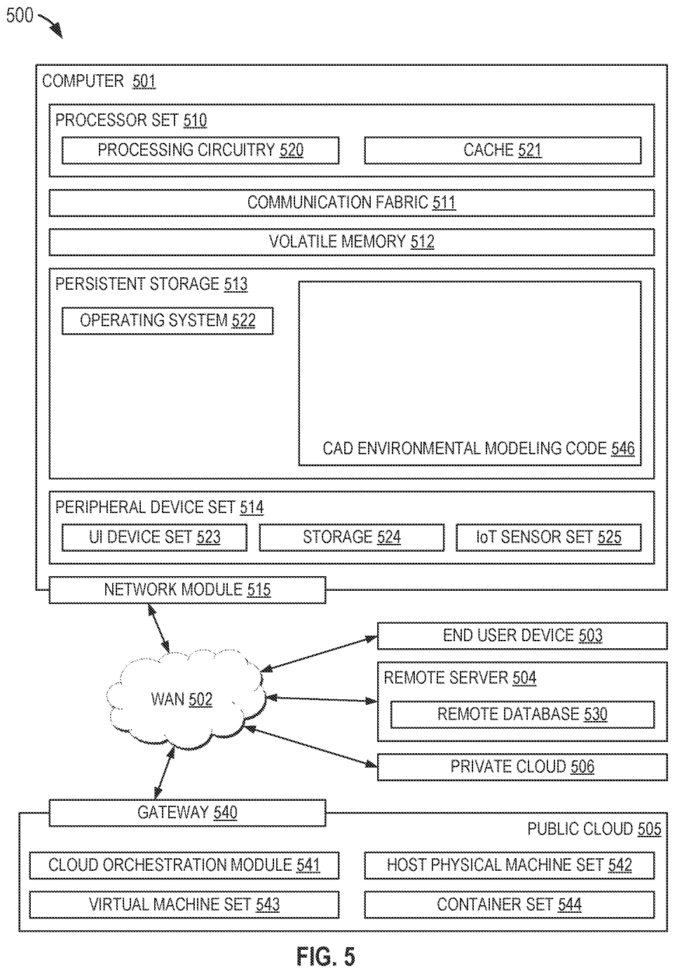

FIG. 2 illustrates a flowchart of an example method 200 for implementing the CAD environmental modeling code to enable replication of a physical area in a CAD workspace and usage of the CAD workspace, in accordance with some embodiments of the present disclosure. In some embodiments, the method 200 can be implemented by one or more components of FIG. 1 and/or FIG. 5.

Operation 202 includes receiving at least one image of a physical area. The image can be received from, for example, spatial data collected by a LIDAR system, photographic data collected by a camera, and/or video data collected by a camera. In embodiments where the image is photographic data or video data, the image can be generated by a user device and transmitted to a computer implementing CAD environmental modeling code via a network.

Operation 204 includes extracting contextual information from the at least one image of the physical area. In some embodiments, the contextual information is derived from the at least one image using AR mapping techniques and/or ML techniques. In some embodiments, the contextual information identifies items in the physical area and differentiates between static items and dynamic items. In some embodiments, the contextual information infers movement information regarding certain dynamic items in the physical area by identifying connectors indicating movement (e.g., hinges, pin connections, roller connections, wheels, slides, etc.) and/or ergonomic features indicating movement (e.g., handles, knobs, buttons, etc.).

Operation 206 includes determining whether sufficient image data is received based on the type, amount, and/or quality of contextual information extracted in operation 204. If not (206: NO), then the method 200 proceeds to operation 208 and generates and transmits imaging instructions. The imaging instructions can be transmitted to a user device and/or presented on a user interface of a computer implementing the CAD environmental modeling code. The imaging instructions can direct the user to obtain additional image data. Thus, the method 200 can subsequently return to operation 202 and receive at least one additional image of the physical area in response to a user device receiving the imaging instructions and obtaining and transmitting the additional image data.

Referring back to operation 206, if sufficient data is received (206: YES), then the method 200 proceeds to operation 210. Operation 210 includes replicating the physical area in a CAD workspace using the contextual information. The replicated physical area can include the static items having fixed coordinates (e.g., indicating no movement) and the dynamic items having ranged coordinates (e.g., indicating movement).

Operation 212 includes creating a modeled object in the CAD workspace. Advantageously, the modeled object can be created in the CAD workspace with the benefit of the replicated physical area infused into the CAD workspace. In this way, a designer or engineer can create the modeled object to fit properly into the physical area for functional, aesthetic, compliance (e.g., building codes), and/or other purposes.

Operation 214 includes generating a print file for the modeled object created in the CAD workspace. Operation 214 can further include disassociating the modeled object from the replicated physical area so that the print file contains solely information about the modeled object (e.g., as if it were modeled in isolation without the benefit of the replicated physical area).

Operation 216 includes transmitting the print file to an additive manufacturing system. Operation 216 can transmit the print file via a network connection, a portable storage device (e.g., USB drive), and/or by another technique.

Operation 218 includes fabricating a printed object using the print file and the additive manufacturing system. Operation 220 includes generating orientation instructions for orienting the printed object in the physical area. The orientation instructions can guide a user to place the printed object in the physical area in a manner consistent with the placement of the modeled object in the replicated physical area of the CAD workspace.

Operation 222 includes transmitting the orientation instructions to a user device. The orientation instructions can be transmitted to the user device, via, for example, a network. In other embodiments, the orientation instructions can be presented on a user interface of the computer implementing the CAD environmental modeling code. In some embodiments, operation 222 includes receiving an image of the printed object placed in the physical area and generating and transmitting additional orientation instructions to the user device and/or the computer, where the additional orientation instructions provide further instructions for correctly placing the printed object in the physical area or a confirmation of a successful placement of the printed object in the physical area.

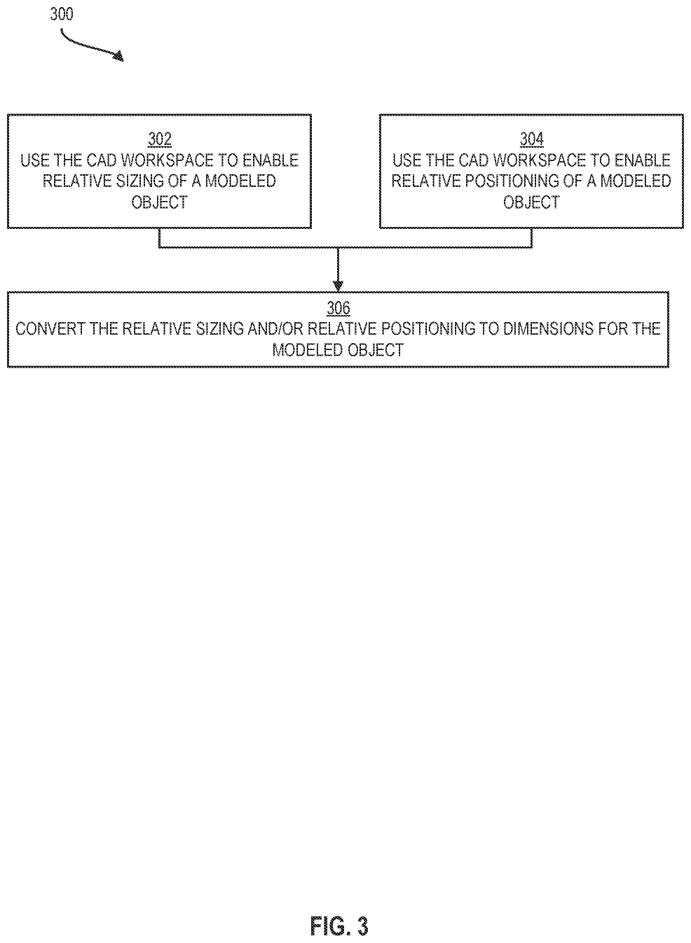

FIG. 3 illustrates a flowchart of an example method 300 for implementing the CAD environmental modeling code to enable relative sizing and/or relative positioning in a CAD workspace replicating a physical area, in accordance with some embodiments of the present disclosure. In some embodiments, the method 300 can be implemented by one or more components of FIG. 1 and/or FIG. 5. In some embodiments, the method 300 is a sub-method of operation 212 of FIG. 2.

Operation 302 includes using the CAD workspace to enable relative sizing of a modeled object. Relative sizing can refer to defining a dimension of the modeled object relative to a feature of a static object or a dynamic object in the replicated physical area. For example, the modeled object can be defined to have a height, width, thickness, circumferences, radius, or other dimension that is an input dimension less than, an input dimension more than, or equal to a height, width, thickness, circumference, radius, or other dimension of the static object or dynamic object in the replicated physical area.

Operation 304 includes using the CAD workspace to enable relative positioning of a modeled object. Relative positioning can refer to defining a position of the modeled object relative to a feature of a static object or a dynamic object in the replicated physical area. For example, the modeled object can be positioned to have an input distance between a feature of the modeled object and a feature of a static object or a dynamic object. Furthermore, in some embodiments, the modeled object can have a relative position based on a maximum, minimum, or other predetermined coordinate of the ranged coordinates associated with the dynamic items. In this way, aspects of the present disclosure can enable the modeled object to avoid interference with a range of motion of a dynamic object by implementing a relative positioning of the modeled object relative to a maximum, minimum, or other (e.g., closest) predetermined coordinate of the ranged coordinates associated with the dynamic item.

As shown in FIG. 3, operations 302 and 304 can occur individually and/or in parallel during modeling in the CAD workspace with the replicated physical area. Furthermore, constraints imposed on the modeled object can drive relative positioning constraints to be converted to relative sizing constraints and/or vice versa. Collectively, the usage of relative sizing and/or relative positioning allow aspects of the present disclosure to improve the accuracy and efficiency of CAD design by enabling designers and/or engineers to dimension to the modeled object relative to other items in the replicated physical area.

Operation 306 includes converting the relative sizing and/or relative positioning to dimensions for the modeled object. The conversion of relative sizing and/or relative positioning to dimensions for the modeled object enable the modeled object to be accurately parsed when generating the print file.

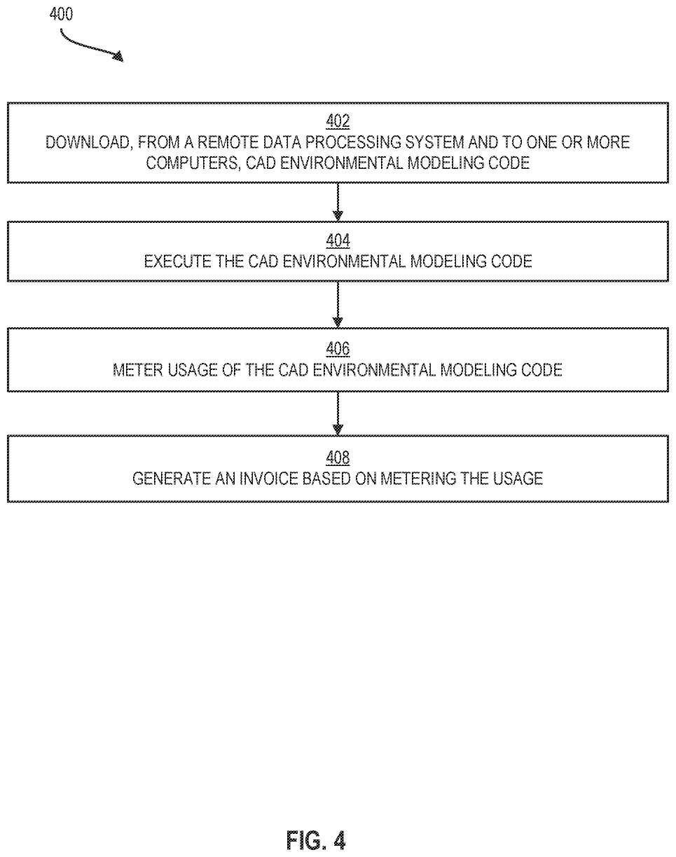

FIG. 4 illustrates a flowchart of an example method 400 for downloading, deploying, metering, and billing usage of CAD environmental modeling code, in accordance with some embodiments of the present disclosure. In some embodiments, the method 400 can be implemented by one or more components of FIG. 1 and/or FIG. 5. In some embodiments, the method 400 occurs concurrently with one or more operations of the method 200 of FIG. 2 and/or the method 300 of FIG. 3.

Operation 402 includes downloading, from a remote data processing system (e.g., remote server 144 of FIG. 1) and to one or more computers (e.g., computer 102 of FIG. 1) CAD environmental modeling code (e.g., CAD environmental modeling code 104 of FIG. 1, CAD environmental modeling code 546 of FIG. 5). Operation 404 includes executing the CAD environmental modeling code. Operation 404 can include performing any of the methods and/or functionalities discussed herein. Operation 406 includes metering usage of the CAD environmental modeling code. Usage can be metered by, for example, an amount of time the CAD environmental modeling code is used, a number of servers and/or devices deploying the CAD environmental modeling code, an amount of resources consumed by implementing the CAD environmental modeling code, a number of replicated physical areas generated by implementing the CAD environmental modeling code, and/or other usage metering metrics. Operation 408 includes generating an invoice based on metering the usage.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 5 illustrates a block diagram of an example computing environment, in accordance with some embodiments of the present disclosure. Computing environment 500 contains an example of an environment for the execution of at least some of the computer code involved in performing the inventive methods, such as CAD environmental modeling code 546. In addition to CAD environmental modeling code 546, computing environment 500 includes, for example, computer 501, wide area network (WAN) 502, end user device (EUD) 503, remote server 504, public cloud 505, and private cloud 506. In this embodiment, computer 501 includes processor set 510 (including processing circuitry 520 and cache 521), communication fabric 511, volatile memory 512, persistent storage 513 (including operating system 522 and CAD environmental modeling code 546, as identified above), peripheral device set 514 (including user interface (UI), device set 523, storage 524, and Internet of Things (IoT) sensor set 525), and network module 515. Remote server 504 includes remote database 530. Public cloud 505 includes gateway 540, cloud orchestration module 541, host physical machine set 542, virtual machine set 543, and container set 544.

COMPUTER 501 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 530. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically computer 501, to keep the presentation as simple as possible. Computer 501 may be located in a cloud, even though it is not shown in a cloud in FIG. 5. On the other hand, computer 501 is not required to be in a cloud except to any extent as may be affirmatively indicated.

PROCESSOR SET 510 includes one, or more, computer processors of any type now known or to be developed in the future. Processing circuitry 520 may be distributed over multiple packages, for example, multiple, coordinated integrated circuit chips. Processing circuitry 520 may implement multiple processor threads and/or multiple processor cores. Cache 521 is memory that is located in the processor chip package(s) and is typically used for data or code that should be available for rapid access by the threads or cores running on processor set 510. Cache memories are typically organized into multiple levels depending upon relative proximity to the processing circuitry. Alternatively, some, or all, of the cache for the processor set may be located “off chip.” In some computing environments, processor set 510 may be designed for working with qubits and performing quantum computing.

Computer readable program instructions are typically loaded onto computer 501 to cause a series of operational steps to be performed by processor set 510 of computer 501 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 521 and the other storage media discussed below. The program instructions, and associated data, are accessed by processor set 510 to control and direct performance of the inventive methods. In computing environment 500, at least some of the instructions for performing the inventive methods may be stored in CAD environmental modeling code 546 in persistent storage 513.

COMMUNICATION FABRIC 511 is the signal conduction paths that allow the various components of computer 501 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 512 is any type of volatile memory now known or to be developed in the future. Examples include dynamic type random access memory (RAM) or static type RAM. Typically, the volatile memory is characterized by random access, but this is not required unless affirmatively indicated. In computer 501, the volatile memory 512 is located in a single package and is internal to computer 501, but, alternatively or additionally, the volatile memory may be distributed over multiple packages and/or located externally with respect to computer 501.

PERSISTENT STORAGE 513 is any form of non-volatile storage for computers that is now known or to be developed in the future. The non-volatility of this storage means that the stored data is maintained regardless of whether power is being supplied to computer 501 and/or directly to persistent storage 513. Persistent storage 513 may be a read only memory (ROM), but typically at least a portion of the persistent storage allows writing of data, deletion of data and re-writing of data. Some familiar forms of persistent storage include magnetic disks and solid state storage devices. Operating system 522 may take several forms, such as various known proprietary operating systems or open source Portable Operating System Interface type operating systems that employ a kernel. The code included in CAD environmental modeling code 546 typically includes at least some of the computer code involved in performing the inventive methods.

PERIPHERAL DEVICE SET 514 includes the set of peripheral devices of computer 501. Data communication connections between the peripheral devices and the other components of computer 501 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 523 may include components such as a display screen, speaker, microphone, wearable devices (such as goggles and smart watches), keyboard, mouse, printer, touchpad, game controllers, and haptic devices. Storage 524 is external storage, such as an external hard drive, or insertable storage, such as an SD card. Storage 524 may be persistent and/or volatile. In some embodiments, storage 524 may take the form of a quantum computing storage device for storing data in the form of qubits. In embodiments where computer 501 is required to have a large amount of storage (for example, where computer 501 locally stores and manages a large database) then this storage may be provided by peripheral storage devices designed for storing very large amounts of data, such as a storage area network (SAN) that is shared by multiple, geographically distributed computers. IoT sensor set 525 is made up of sensors that can be used in Internet of Things applications. For example, one sensor may be a thermometer and another sensor may be a motion detector.

NETWORK MODULE 515 is the collection of computer software, hardware, and firmware that allows computer 501 to communicate with other computers through WAN 502. Network module 515 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 515 are performed on the same physical hardware device. In other embodiments (for example, embodiments that utilize software-defined networking (SDN)), the control functions and the forwarding functions of network module 515 are performed on physically separate devices, such that the control functions manage several different network hardware devices. Computer readable program instructions for performing the inventive methods can typically be downloaded to computer 501 from an external computer or external storage device through a network adapter card or network interface included in network module 515.

WAN 502 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 503 is any computer system that is used and controlled by an end user (for example, a customer of an enterprise that operates computer 501), and may take any of the forms discussed above in connection with computer 501. EUD 503 typically receives helpful and useful data from the operations of computer 501. For example, in a hypothetical case where computer 501 is designed to provide a recommendation to an end user, this recommendation would typically be communicated from network module 515 of computer 501 through WAN 502 to EUD 503. In this way, EUD 503 can display, or otherwise present, the recommendation to an end user. In some embodiments, EUD 503 may be a client device, such as thin client, heavy client, mainframe computer, desktop computer and so on.

REMOTE SERVER 504 is any computer system that serves at least some data and/or functionality to computer 501. Remote server 504 may be controlled and used by the same entity that operates computer 501. Remote server 504 represents the machine(s) that collect and store helpful and useful data for use by other computers, such as computer 501. For example, in a hypothetical case where computer 501 is designed and programmed to provide a recommendation based on historical data, then this historical data may be provided to computer 501 from remote database 530 of remote server 504.

PUBLIC CLOUD 505 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 505 is performed by the computer hardware and/or software of cloud orchestration module 541. The computing resources provided by public cloud 505 are typically implemented by virtual computing environments that run on various computers making up the computers of host physical machine set 542, which is the universe of physical computers in and/or available to public cloud 505. The virtual computing environments (VCEs) typically take the form of virtual machines from virtual machine set 543 and/or containers from container set 544. It is understood that these VCEs may be stored as images and may be transferred among and between the various physical machine hosts, either as images or after instantiation of the VCE. Cloud orchestration module 541 manages the transfer and storage of images, deploys new instantiations of VCEs and manages active instantiations of VCE deployments. Gateway 540 is the collection of computer software, hardware, and firmware that allows public cloud 505 to communicate through WAN 502.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 506 is similar to public cloud 505, except that the computing resources are only available for use by a single enterprise. While private cloud 506 is depicted as being in communication with WAN 502, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 505 and private cloud 506 are both part of a larger hybrid cloud.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding of the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

A non-limiting list of examples are provided hereinafter to demonstrate some aspects of the present disclosure. Example 1 is a computer-implemented method. The method includes extracting, by augmented reality mapping techniques, contextual information from at least one image of a physical area including a static object and a dynamic object; replicating the physical area in a Computer Aided Design (CAD) workspace using the contextual information, wherein the static object is associated with a single set of coordinates, and wherein the dynamic object is associate with a range of coordinates representing movement; and generating a print file for a modeled object created in the CAD workspace, wherein the print file includes computer-readable instructions for fabricating the modeled object by additive manufacturing.

Example 2 includes the features of Example 1. In this example, the at least one image is derived from one or more selected from a group consisting of: a Light Detection and Ranging (LIDAR) system, video data, and photographic data.

Example 3 includes the features of any one of Examples 1 to 2, including or excluding optional features. In this example, the method further includes transmitting the print file to an additive manufacturing system; and fabricating a printed object corresponding to the modeled object using the additive manufacturing system and the print file. Optionally, the method further includes generating orientation instructions for orienting the printed object in the physical area; and transmitting the orientation instructions to a user device.

Example 4 includes the features of any one of Examples 1 to 3, including or excluding optional features. In this example, the extracting the contextual information further comprises: determining that the at least one image contains insufficient data to replicate the physical area in the CAD workspace; transmitting imaging instructions to a user device for obtaining additional images; and receiving the additional images.

Example 5 includes the features of any one of Examples 1 to 4, including or excluding optional features. In this example, the method is performed by a computer implementing CAD environmental modeling code, and wherein the method further comprises: metering usage of the CAD environmental modeling code; and generating an invoice based on metering usage of the CAD environmental modeling code.

Example 6 is a computer-implemented method. The method includes replicating a physical area in a Computer Aided Design (CAD) workspace, wherein a static object of the physical area is replicated in the CAD workspace with a single set of coordinates, and wherein a dynamic object of the physical area is replicated in the CAD workspace with a range of coordinates representing movement; and using the CAD workspace to enable relative sizing of a modeled object in the CAD workspace, wherein the relative sizing is relative to the single set of coordinates associated with the static object and the range of coordinates associated with the dynamic object.

Example 7 includes the features of Example 6. In this example, the method further includes generating a print file for the modeled object, wherein the print file is configured to enable an additive manufacturing system to fabricate a printed object corresponding to the modeled object. Optionally, the method further includes fabricating the printed object using the additive manufacturing system. Optionally, the method further includes transmitting, to a user device, orientation instructions for orienting the printed object in the physical area.

Example 8 includes the features of any one of Examples 6 to 7, in this example, the method further includes using the CAD workspace to enable relative positioning of the modeled object in the CAD workspace, wherein the relative positioning is relative to the single set of coordinates associated with the static object and the range of coordinates associated with the dynamic object.

Example 9 is a system. The system includes one or more computer readable storage media storing program instructions; and one or more processors which, in response to executing the program instructions, are configured to perform a method according to any one of Examples 1 to 8, including or excluding optional features.

Example 10 is a computer program product. The computer program product includes one or more computer readable storage media, and program instructions collectively stored on the one or more computer readable storage media, the program instructions comprising instructions configured to cause one or more processors to perform a method according to any one of Examples 1 to 8, including or excluding optional features.

Example 11 is a system. The system includes a Light Ranging And Detection (LIDAR) system configured to generate spatial data for a physical area; a computer implementing Computer Aided Design (CAD) environmental modeling code configured to replicate the physical area in a CAD workspace using the spatial data and generate a print file corresponding to a modeled object created in the CAD workspace; an additive manufacturing system configured to fabricate a printed object corresponding to the modeled object and based on the print file; and a user device configured to receive orientation instructions for placing the printed object in the physical area.

Example 12 includes the features of Example 11. In this example, the user device is further configured to receive imaging instructions for adjusting the LIDAR system to generate additional spatial data for the physical area, and wherein replicating the physical area in the CAD workspace is further based on the additional spatial data.

Example 13 includes the features of any one of Examples 11 to 12, including or excluding optional features. In this example, the user device is further configured to receive orientation instructions for orienting the printed object in the physical area.

Example 14 includes the features of any one of Examples 11 to 13, including or excluding optional features. In this example, the modeled object has dimensions based on relative sizing or relative positioning to replicated physical area objects in the CAD workspace.

What is claimed is:

1. A computer-implemented method comprising:
extracting, by augmented reality mapping techniques, contextual information from at least one image of a physical area including a static object and a dynamic object;
replicating the physical area in a Computer Aided Design (CAD) workspace using the contextual information, wherein the static object is associated with a single set of coordinates, and wherein the dynamic object is associate with a range of coordinates representing movement; and
generating a print file for a modeled object created in the CAD workspace, wherein the print file includes computer-readable instructions for fabricating the modeled object by additive manufacturing.

2. The computer-implemented method of claim 1, wherein the at least one image is derived from a Light Detection and Ranging (LIDAR) system.

3. The computer-implemented method of claim 1, wherein the at least one image is derived from video data.

4. The computer-implemented method of claim 1, wherein the at least one image is derived from photographic data.

5. The computer-implemented method of claim 1, further comprising:
transmitting the print file to an additive manufacturing system; and
fabricating a printed object corresponding to the modeled object using the additive manufacturing system and the print file.

6. The computer-implemented method of claim 5, further comprising:
generating orientation instructions for orienting the printed object in the physical area; and
transmitting the orientation instructions to a user device.

7. The computer-implemented method of claim 1, wherein extracting the contextual information further comprises:
determining that the at least one image contains insufficient data to replicate the physical area in the CAD workspace;
transmitting imaging instructions to a user device for obtaining additional images; and
receiving the additional images.

8. The computer-implemented method of claim 1, wherein the method is performed by a computer implementing CAD environmental modeling code, and wherein the method further comprises:
metering usage of the CAD environmental modeling code; and
generating an invoice based on metering usage of the CAD environmental modeling code.

9. A system comprising:
one or more computer readable storage media storing program instructions; and
one or more processors which, in response to executing the program instructions, are configured to perform a method comprising:
extracting, by augmented reality mapping techniques, contextual information from at least one image of a physical area including a static object and a dynamic object;
replicating the physical area in a Computer Aided Design (CAD) workspace using the contextual information, wherein the static object is associated with a single set of coordinates, and wherein the dynamic object is associate with a range of coordinates representing movement; and
generating a print file for a modeled object created in the CAD workspace, wherein the print file includes computer-readable instructions for fabricating the modeled object by additive manufacturing.

10. The system of claim 9, wherein the at least one image is derived from at least one selected from a group consisting of: a Light Detection and Ranging (LIDAR) system, video data, and photographic data.

11. The system of claim 9, the one or more computer readable storage media storing additional program instructions, wherein the additional program instructions cause the one or more processors to perform the method further comprising:
transmitting the print file to an additive manufacturing system;
fabricating a printed object corresponding to the modeled object using the additive manufacturing system and the print file;
generating orientation instructions for orienting the printed object in the physical area; and
transmitting the orientation instructions to a user device.

12. The system of claim 9, wherein extracting the contextual information further comprises:
determining that the at least one image contains insufficient data to replicate the physical area in the CAD workspace;
transmitting imaging instructions to a user device for obtaining additional images; and
receiving the additional images.

13. A computer program product comprising one or more computer readable storage media, and program instructions collectively stored on the one or more computer readable storage media, the program instructions comprising instructions configured to cause one or more processors to perform a method comprising:
extracting, by augmented reality mapping techniques, contextual information from at least one image of a physical area including a static object and a dynamic object;
replicating the physical area in a Computer Aided Design (CAD) workspace using the contextual information, wherein the static object is associated with a single set of coordinates, and wherein the dynamic object is associate with a range of coordinates representing movement; and
generating a print file for a modeled object created in the CAD workspace, wherein the print file includes computer-readable instructions for fabricating the modeled object by additive manufacturing.

14. The computer program product of claim 13, wherein the at least one image is derived from at least one selected from a group consisting of: a Light Detection and Ranging (LIDAR) system, video data, and photographic data.

15. The computer program product of claim 13, the one or more computer readable storage media storing additional program instructions configured to cause the one or more processors to perform the method further comprising:
transmitting the print file to an additive manufacturing system;
fabricating a printed object corresponding to the modeled object using the additive manufacturing system and the print file;
generating orientation instructions for orienting the printed object in the physical area; and
transmitting the orientation instructions to a user device.

16. The computer program product of claim 13, wherein extracting the contextual information further comprises:
determining that the at least one image contains insufficient data to replicate the physical area in the CAD workspace;
transmitting imaging instructions to a user device for obtaining additional images; and
receiving the additional images.

17. A system comprising:
a Light Ranging And Detection (LIDAR) system configured to generate spatial data for a physical area;
a computer implementing Computer Aided Design (CAD) environmental modeling code configured to replicate the physical area in a CAD workspace using the spatial data and generate a print file corresponding to a modeled object created in the CAD workspace;
an additive manufacturing system configured to fabricate a printed object corresponding to the modeled object and based on the print file; and
a user device configured to receive orientation instructions for placing the printed object in the physical area.

18. The system of claim 17, wherein the user device is further configured to receive imaging instructions for adjusting the LIDAR system to generate additional spatial data for the physical area, and wherein replicating the physical area in the CAD workspace is further based on the additional spatial data.

19. The system of claim 17, wherein the user device is further configured to receive orientation instructions for orienting the printed object in the physical area.

20. The system of claim 17, wherein the modeled object has dimensions based on relative sizing or relative positioning to replicated physical area objects in the CAD workspace.

21. A computer-implemented method comprising:
replicating a physical area in a Computer Aided Design (CAD) workspace, wherein a static object of the physical area is replicated in the CAD workspace with a single set of coordinates, and wherein a dynamic object of the physical area is replicated in the CAD workspace with a range of coordinates that represents movement; and
using the CAD workspace to enable relative sizing of a modeled object in the CAD workspace, wherein the relative sizing is relative to the single set of coordinates associated with the static object and the range of coordinates associated with the dynamic object.

22. The computer-implemented method of claim 21, further comprising:
generating a print file for the modeled object, wherein the print file is configured to enable an additive manufacturing system to fabricate a printed object corresponding to the modeled object.

23. The computer-implemented method of claim 22, further comprising:
fabricating the printed object using the additive manufacturing system.

24. The computer-implemented method of claim 23, further comprising:
transmitting, to a user device, orientation instructions for orienting the printed object in the physical area.

25. The computer-implemented method of claim 21, further comprising:
using the CAD workspace to enable relative positioning of the modeled object in the CAD workspace, wherein the relative positioning is relative to the single set of coordinates associated with the static object and the range of coordinates associated with the dynamic object.
